(19) United States
(12) Patent Application Publication
(10) Pub. No.: US 2016/0256821 A1
(43) Pub. Date: Sep. 8, 2016

(54) VERSATILE DEHUMIDIFICATION PROCESS AND APPARATUS USING A HYDROPHOBIC MEMBRANE

(71) Applicant: Nanocap Technologies, LLC, West Hartford, CT (US)

(72) Inventors: Arthur S. Kesten, West Hartford, CT (US); Jack N. Blechner, West Hartford, CT (US); Ariel K. Girelli, Glastonbury, CT (US); Marianne Pemberton, Manchester, CT (US)

(21) Appl. No.: 15/054,670

(22) Filed: Feb. 26, 2016

Related U.S. Application Data
(60) Provisional application No. 62/176,856, filed on Mar. 2, 2015.

(51) Int. Cl. B01D 53/26; F24F 3/14

(52) U.S. Cl. CPC B01D 53/268; F24F 3/1417; F24F 2003/1435

(57) ABSTRACT

An apparatus and process for dehumidification of a gas stream are provided. The apparatus includes a single semi-permeable osmotic membrane, at least one gas stream compartment, and at least one osmotic fluid compartment. The membrane includes a plurality of hydrophobic surfaced pores, at least some of which hydrophobic surfaced pores are water vapor condensing pores. The water vapor condensing pores are sized such that the hydrophobic surfaces of those pores allow water vapor to enter those pores and repulse the water vapor within those pores away from the hydrophobic surfaces causing the water vapor to condense. The hydrophobic surfaced pores provide a liquid travel path across the thickness of the membrane. The membrane restricts transport of an osmotic fluid across the thickness of the membrane. A refrigeration system utilizing a dehumidification unit and a heat pump system utilizing a dehumidification unit are also disclosed.

This application claims priority to U.S. Patent Application Ser. No. 62/176,856 filed Mar. 2, 2015, which is herein incorporated by reference in its entirety.

### BACKGROUND OF THE INVENTION

1. Technical Field

This invention relates to processes and apparatus for dehumidifying a gas, such as air, and to the dehumidification of a gas in an enclosed volume in particular.

2. Background Information

U.S. Pat. Nos. 6,539,731 and 7,758,671 disclose dehumidification devices that utilize an osmotic fluid to remove water from an airflow. The '731 patent discloses a device having a porous wall comprising a hydrophilic condensing layer and a hydrophilic or hydrophobic osmotic layer. The porous wall separates the osmotic fluid from the airflow. An osmotic driving force, resulting from a water concentration gradient, draws water vapor into contact with the condensing layer, transports liquid water condensed within the condensing layer through the condensing layer and into contact with the osmotic layer. The osmotic layer is permeable to water but not to solute dissolved in the osmotic fluid. Liquid water transfers through the osmotic layer and into the osmotic fluid. The '671 Patent discloses a device having a hydrophilic membrane with randomly arranged pores disposed across a thickness extending between a first side and a second side. Some of the randomly arranged pores are small enough to permit capillary condensation within the membrane, leading to condensate travel across the thickness of the single membrane without requiring a separate capillary condenser. The single membrane restricts transport of an osmotic fluid across the thickness of the membrane.

### DISCLOSURE OF INVENTION

According to an aspect of the present disclosure, an apparatus for dehumidification of a gas stream is provided. The apparatus includes a single semi-permeable osmotic membrane, at least one gas stream compartment, and at least one osmotic fluid compartment. The single semi-permeable osmotic membrane has a thickness extending between a first side surface and a second side surface. The membrane includes a plurality of hydrophobic surfaced pores, at least some of which hydrophobic surfaced pores are water vapor condensing pores. The water vapor condensing pores are sized such that the hydrophobic surfaces of those pores allow water vapor to enter those pores and repulse the water vapor within those pores away from the hydrophobic surfaces causing the water vapor to condense. The hydrophobic surfaced pores provide a liquid travel path across the thickness of the membrane. The membrane restricts transport of an osmotic fluid across the thickness of the membrane. The gas stream compartment is formed in part by the osmotic membrane; i.e., the first side of the osmotic membrane is positioned so as to be exposed to the gas stream within the gas stream compartment. The osmotic fluid compartment is formed in part by the osmotic membrane; i.e., the second side of the osmotic membrane is contiguous with the osmotic fluid compartment.

According to another aspect of the present disclosure, a process for dehumidifying a gas stream is provided. The process includes the steps of: a) providing an osmotic fluid; b) providing a single semi-permeable hydrophobic osmotic membrane having a thickness extending between a first side surface and a second side surface, which membrane comprises a plurality of hydrophobic surfaced pores, at least some of which are hydrophobic pores are water vapor condensing pores, which water vapor condensing pores are sized such that the hydrophobic surfaces of those pores allow water vapor to enter those pores and repulse the water vapor within those pores away from the hydrophobic surfaces causing the water vapor to condense and travel through a liquid travel path across the thickness of the membrane, and which single membrane restricts transport of an osmotic fluid across the thickness of the membrane; c) placing the osmotic fluid in a compartment formed in part by the semi-permeable membrane, wherein the second side of the osmotic membrane is exposed to the osmotic fluid; d) exposing the first side of the osmotic membrane to the gas stream to be dehumidified; and e) maintaining a sufficiently high water concentration gradient across the osmotic membrane during the dehumidification process to result in a flux of water through the osmotic membrane.

According to another aspect of the present disclosure, a refrigeration system is provided that includes a refrigeration unit, an airflow dehumidification unit, and airflow ducting extending between the refrigeration unit and the airflow dehumidification unit. The refrigeration unit includes an interior volume and a cooling unit configured to cool air disposed within the interior volume to a temperature below ambient. The airflow dehumidification unit includes a semi-permeable osmotic membrane, at least one airflow compartment, and at least one osmotic fluid compartment. The semi-permeable osmotic membrane has a thickness extending between a first side surface and a second side surface. The membrane includes a plurality of pores, which pores provide a liquid travel path across the thickness of the membrane. The membrane restricts transport of an osmotic fluid across the thickness of the membrane. The airflow compartment is formed in part by the osmotic membrane; i.e., the first side of the osmotic membrane is positioned so as to be exposed to the airflow within the airflow compartment. The osmotic fluid compartment is formed in part by the osmotic membrane; i.e., the second side of the osmotic membrane is contiguous with the osmotic fluid compartment. The airflow ducting is configured to contain an airflow from the interior volume of the refrigeration unit to an inlet of the airflow compartment, and from an exit of the airflow compartment to the interior volume of the refrigeration unit.

According to another aspect of the present disclosure, a heat pump system for a building is provided. The system includes a heat pump, an airflow dehumidification unit, and a two-fluid heat exchanger. The heat pump has a refrigerant, a refrigerant piping loop through which the refrigerant travels, and an evaporator disposed outside of the building, which evaporator is exposed to ambient air. The airflow dehumidification unit includes a semi-permeable osmotic membrane, at least one airflow compartment, and at least one osmotic fluid compartment. The semi-permeable osmotic membrane has a thickness extending between a first side surface and a second side surface. The membrane comprises a plurality of pores, which pores provide a liquid travel path across the thickness of the membrane. The membrane restricts transport of an osmotic fluid across the thickness of the membrane. The airflow compartment is formed in part by the osmotic membrane; e.g., the first side of the osmotic membrane is positioned so as to be exposed to the airflow within the airflow compartment. The osmotic fluid compartment is formed in part by the osmotic membrane; the second side of the osmotic membrane forms at least a portion of a wall of the osmotic fluid compartment. The two-fluid heat exchanger has a refrigerant inlet and a refrigerant outlet, an osmotic fluid inlet, and an osmotic fluid outlet. Piping is provided to form an enclosed osmotic fluid path loop from the osmotic fluid compartment to the osmotic fluid inlet of the heat exchanger, and from the osmotic fluid exit of the heat exchanger back to the osmotic fluid compartment. The system includes airflow ducting configured to provide an enclosed passage for an airflow exiting the airflow compartment to the evaporator.

These and other objects, features, and advantages of the present invention method and apparatus will become apparent in light of the detailed description of the invention provided below and the accompanying drawings. The methodology and apparatus described below constitute a preferred embodiment of the underlying invention and do not, therefore, constitute all aspects of the invention that will or may become apparent by one of skill in the art after consideration of the invention disclosed overall herein.

### BRIEF DESCRIPTION OF DRAWINGS

FIG. 1 is a schematic view of a prior art air dehumidifying system.

FIG. 2 is a schematic sectional view of an osmotic membrane according to the present disclosure.

FIG. 2A is a schematic sectional view of a pore within an osmotic membrane according to the present disclosure.

FIG. 3 is a schematic diagram of a refrigeration system.

FIG. 4 is a schematic diagram of a heat pump system.

### BEST MODE FOR CARRYING OUT THE INVENTION

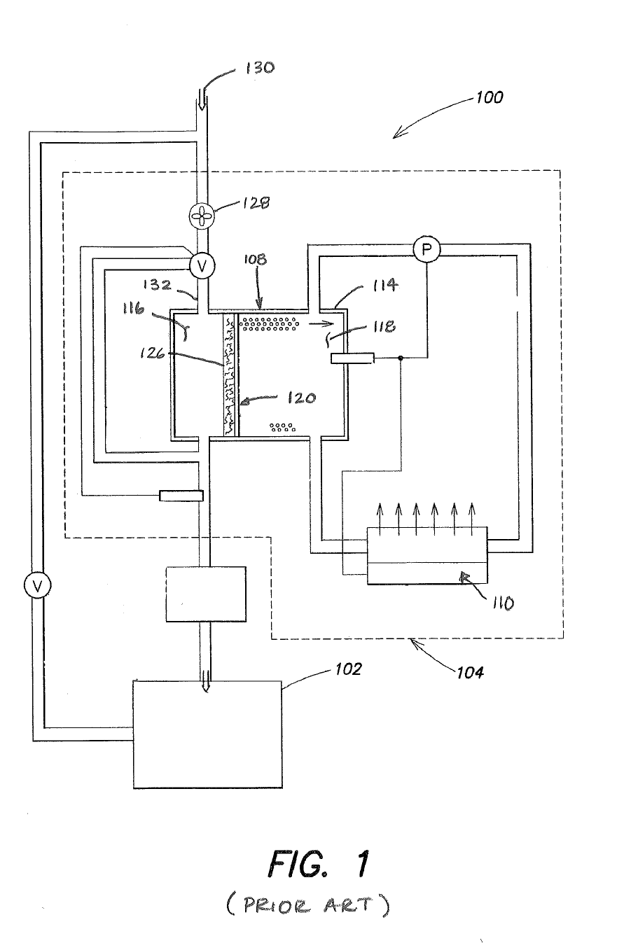

The present disclosure is directed to a dehumidifying process and apparatus that utilizes a hydrophobic membrane operable to condense water vapor present in a gas (e.g., air) and transport that water into an osmotic fluid. As indicated above, U.S. Pat. Nos. 6,539,731 and 7,758,671 disclose dehumidification devices that utilize an osmotic fluid to remove water from an airflow. To facilitate the description of the present apparatus and process, FIG. 1 of U.S. Pat. No. 7,758,671 is provided herewith to illustrate an example of a system within which the present process and apparatus can be used. The present disclosure is not limited to this particular embodiment.

FIG. 1 from the '671 Patent schematically depict an air dehumidifying system 100 for dehumidifying a gas (e.g., air) that may reside within an enclosed compartment 102. The system 100 includes dehumidification apparatus 104 (represented by the components within the dotted line) having a dehumidifier 108 and an evaporator 110. The dehumidifier 108 is schematically depicted as an enclosure 114 divided into an airflow compartment 116 and an osmotic fluid compartment 118. The osmotic fluid compartment 118 contains an osmotic fluid. The compartments 116, 118 are separated by an osmotic wall 120 comprising a semi-permeable osmotic membrane 126. A fan 128 or other suitable airflow generator draws air to be dehumidified (represented by the arrow 130) into an inlet duct 132 and blows it into and through the airflow compartment 116. As the air passes through the airflow compartment 116 of the dehumidifier 108, the air contacts the osmotic membrane 126. At least a portion of water vapor in the air condenses into liquid form within the pores of the osmotic membrane 126. The water subsequently travels through the osmotic membrane 126 into the osmotic fluid within the compartment 118. The air, now lower in humidity (i.e., containing less water vapor), exits the air flow compartment 116. The osmotic fluid includes solute molecules that cause the liquid water to go into solution within the osmotic fluid. Various techniques and apparatus are available to subsequently remove the water from the osmotic fluid if so desired. As indicated above, U.S. Pat. Nos. 6,539,731 and 7,758,671, each of which is hereby incorporated by reference in its entirety, disclose specific exemplary details of such dehumidification devices. Hence, further description is not necessary for enablement of the present disclosure.

The present disclosure provides a significant improvement over the aforesaid devices/systems. In particular, the present disclosure includes dehumidification devices, systems, and processes that utilize an osmotic membrane with greatly enhanced dehumidification performance.

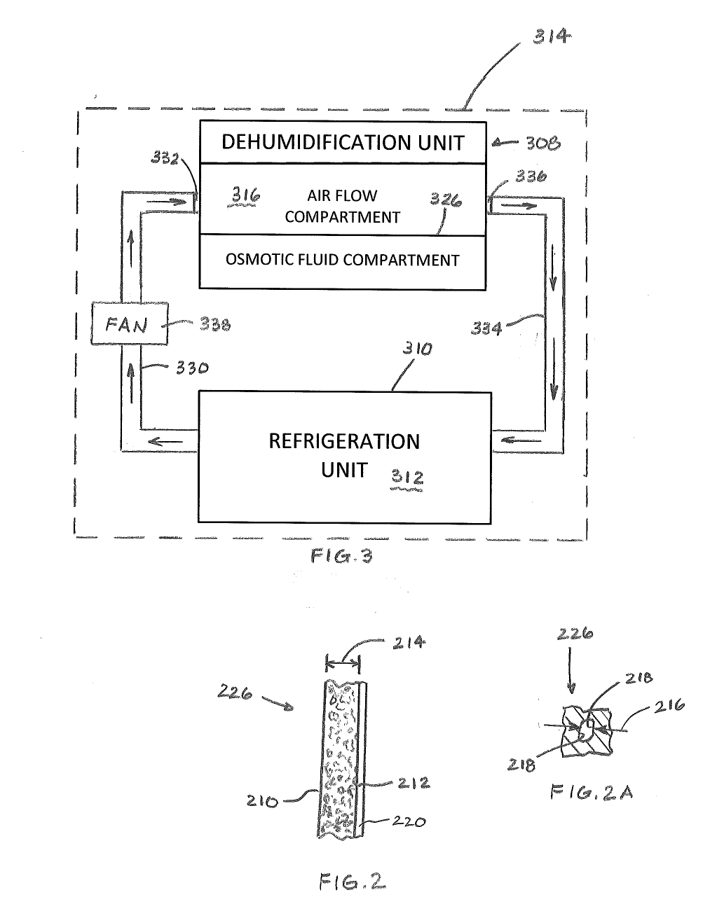

Referring to FIGS. 2 and 2A, the osmotic membrane 226 according to the present disclosure has a first side surface 210 and a second side surface 212, and a thickness 214 extending there between. The osmotic membrane 226 is a porous structure having hydrophobic surfaced pores, each of which may be described as having a “diameter”. The term “diameter” as used herein does not mean that the pores are circular, but rather refers to a minimum distance (shown in FIG. 2A as dimension 216) between opposing interior surfaces 218 of a pore. Indeed, depending on the particular membrane material and/or the manner in which the pores are formed, the pores within the membrane 226 may assume different specific geometries within the membrane. A substantial percentage of the pores within the membrane 226 have a diameter that promotes condensation of water within the membrane 226 and prevents hydrated solute molecules present within the osmotic fluid from entering the membrane 226. These pores may be referred to hereinafter as “water vapor condensing pores”. The term “substantial percentage” is used herein to mean that the number of pores in the above-described diameter range is great enough within the membrane 226 (relative to pores having a diameter outside the aforesaid range) so that the membrane's trans-thickness water transfer characteristics are predominated by the pores in the aforesaid diameter range. Specific pores may not extend the entirety of membrane thickness 214. The configuration of the porous membrane 226 may be multiple pores disposed adjacent one another across the thickness of the membrane 226. Collectively, these pores form paths through which condensed water can travel across the thickness 214 of the membrane 226 in the direction from the first side 210 of the osmotic membrane 226 (exposed to the air to be dehumidified) to the second side 212 of the membrane 226 (exposed to the osmotic fluid). Because the membrane 226 is so thin, water concentration gradients across the membrane 226 can be large, creating a large driving force for water transport between the air to be dehumidified and the osmotic fluid.

The osmotic membrane of the present disclosure has a substantial percentage of hydrophobic surfaced pores in the diameter range of about 0.8 nanometers (nm) to about 1.4 nm (i.e., water vapor condensing pores), which pores at least in part provide a fluid transfer path across the thickness 214 of the membrane 226. Hydrophobic surfaced pores having a diameter below about 0.8 nm do not appreciably contribute to water vapor condensation within a membrane 226 such as that described herein; e.g., because the hydrophobic forces associated with the pore surface are adequate to substantially prevent water vapor from entering pores of this size. Hydrophobic surfaced pores having a diameter above about 1.4 nm also do not appreciably contribute to water vapor condensation within a membrane 226 such as that described herein; e.g., it is understood that pores larger than about 1.4 nm fill with water vapor and do not form water condensate. Repulsive forces associated with hydrophobic surfaced pores in the identified pore diameter range, in contrast, drive water vapor molecules away from the aforesaid hydrophobic surfaces and create a water molecule density gradient that results in water molecule cluster formation that, in turn, results in rapid water condensation; i.e., rapid relative to water vapor condensation that occurs in non-hydrophobic membranes such as those described in the prior art. The permeation of condensed water through the membrane 226 is rapid due at least in part to the reduced friction resulting from the repulsion of water from the hydrophobic pore surfaces. Hydrophobic surfaced pores having a diameter at or below about 1.0 nm also work well to prevent most osmotic fluid solutes from entering the osmotic membrane 226; i.e., solute molecules useful within an osmotic fluid typically have a hydrated diameter greater than 1.0 nm and therefore cannot enter the membrane pores. The specific osmotic fluid and the specific osmotic fluid membrane pore diameters are preferably coordinated so that solute molecules within the osmotic fluid do not appreciably enter the osmotic membrane 226, or appreciably block membrane pores in a manner that would inhibit water transfer across the thickness 214 of the osmotic membrane 226.

The osmotic membrane 226 is not limited to any particular type of material, provided the pore surfaces within the membrane 226 are hydrophobic. For example, the osmotic membrane 226 may consist of a hydrophobic material, with the pore surfaces therefore being inherently hydrophobic. Alternatively, in some embodiments the pores surfaces of the osmotic membrane 226 may be treated (e.g., coated with a material) that causes the pore surfaces to hydrophobic. The osmotic membrane material may be formed to inherently have a porous structure. Specifically, the membrane material may be formed to inherently have a substantial percentage of pores in the above-described diameter range. As indicated above, the term “substantial percentage” is used herein to mean that the number of pores in the above-described diameter range is great enough within the membrane 226 (relative to pores having a diameter outside the aforesaid range) so that the membrane's trans-thickness water transfer characteristics are predominated by the pores in the aforesaid diameter range. Alternatively, the pores in the osmotic membrane 226 may formed via a manufacturing process (e.g., perforation). An osmotic membrane 226 made of a non-rigid polymeric material(s) is particularly advantageous; e.g., the flexibility allows the membrane 226 to be Banned in non-planar configurations. A non-limited example of a material that can be used to form an osmotic membrane 226 according to the present disclosure is an Aquaporin Inside® membrane, commercially offered by Aquaporin A/S of Copenhagen, Denmark. Osmotic dehumidification has been demonstrated in a laboratory scale device using an Aquaporin Inside® membrane, with magnesium chloride used as an osmotic fluid solute. Water fluxes obtained with such a system were more than twice those obtained with available prior art hydrophilic polymeric membranes.

The thickness 214 of the osmotic membrane 226 may be chosen based on the characteristics of the system within which it is used. Generally speaking, the thinner the osmotic membrane 226, the greater the water flux through the membrane 226 and into the osmotic fluid, since flux across the osmotic membrane 226 is inversely proportional to the thickness of the osmotic membrane 226. The thickness 214 of the osmotic membrane 226 is also chosen to provide adequate structural integrity and durability.

The osmotic membrane 226 may be structurally supported by a support structure 220. The support structure 220 may comprise the same material as the osmotic membrane 226, a different material, or some combination thereof. The support structure 220 may be disposed on one or both sides of the osmotic membrane 226, or be integral with the osmotic membrane 226. The support structure 220 does not significantly inhibit airflow (including any water vapor that may be present within the airflow) from accessing the first side 210 of the osmotic membrane 226 or inhibit osmotic fluid from accessing the second side 212 of the osmotic membrane 226.

The water flux across the osmotic membrane 226 is a function of the membrane's permeability and the water concentration difference across the osmotic membrane 226. Flux equals the product of permeability, cross sectional area, and concentration difference across the membrane 226. The permeability is inversely proportional to the membrane thickness 214. Because the membrane 226 is so thin, water concentration gradients across the membrane 226 can be large. This can provide a large driving force for water transport between the humid air and osmotic fluid.

The present disclosure may be used with a variety of different osmotic fluids, and therefore is not limited to use with any particular osmotic fluid. Osmotic fluids are known in the art, and are disclosed in U.S. Pat. Nos. 6,539,731 and 7,758,671 (both of which are incorporated by reference), and will not be further described herein. As provided above, however, the specific osmotic fluid to be used is preferably selected in coordination with the osmotic fluid membrane 226 to be used so that the membrane pore diameters are sized to appreciably prevent solute molecules within the osmotic fluid from entering the osmotic membrane 226, or to avoid the solute molecules from appreciably blocking the osmotic membrane pores.

The present disclosure includes several novel and desirable applications. For example, referring to the diagram shown in FIG. 3, a dehumidification device 308 according to the present disclosure can be used to enhance the performance of a refrigeration unit 310 having an enclosed interior space 312 maintained at a below ambient temperature. Refrigeration units 310 such as freezers, refrigerators, and the like utilize a cooling device (not shown) to maintain air disposed within an interior space (i.e., volume) at a lower than ambient temperature. Typically, the interior space 312 of these type units have one or more doors that allow a user to access the interior space 312; e.g., to place items into or remove items from the interior space. When the interior space door is opened, some amount of ambient air is drawn into the interior space 312 and once the door is closed, that ambient air is captured within the interior space 312. Depending on the circumstances, moisture within the captured ambient air can attach to surfaces within the interior space 312 in the form of frost. Frost build up can be particularly problematic for refrigeration units 310 that are opened often, and which are used in a humid ambient air environment; e.g., a “freezer” unit used in a food market application, where consumers are constantly opening the unit to access goods stored inside. During the summer months when ambient air can be particularly humid, the buildup of frost within such a unit can be significant. According to the present disclosure, a system 314 is provided that includes a refrigeration unit 310 and a dehumidification unit 308 as described above. The refrigeration unit 310 includes an interior space/volume 312 that is maintained at a temperature below ambient. A first duct 330 connects an airflow inlet 332 of the dehumidification device 308 (which inlet 332 allows air to enter the airflow compartment 316 of the dehumidification device 308) to the interior space 312 of the refrigeration unit 310 and a second duct 334 connects the airflow exit 336 of the dehumidification device 308 (which exit 336 allows air to exit the airflow compartment 316 of the dehumidification device 308) to the refrigeration device interior space 312. A fan 338, or other air moving device, draws air from the interior space 312 of the refrigeration device 310, passes it through the first duct 330 and into the dehumidification device 308. The air subsequently travels through the dehumidification device 308 (e.g., having an osmotic membrane 326 as described above) where water vapor is removed from the airflow as described above. The dehumidified air subsequently returns to the refrigeration device interior space 312 via the second duct 334. The dehumidified air now disposed within the refrigeration interior space 312 contains less water vapor and therefore has less potential for creating frost within the interior space 312 of the refrigeration unit 310.

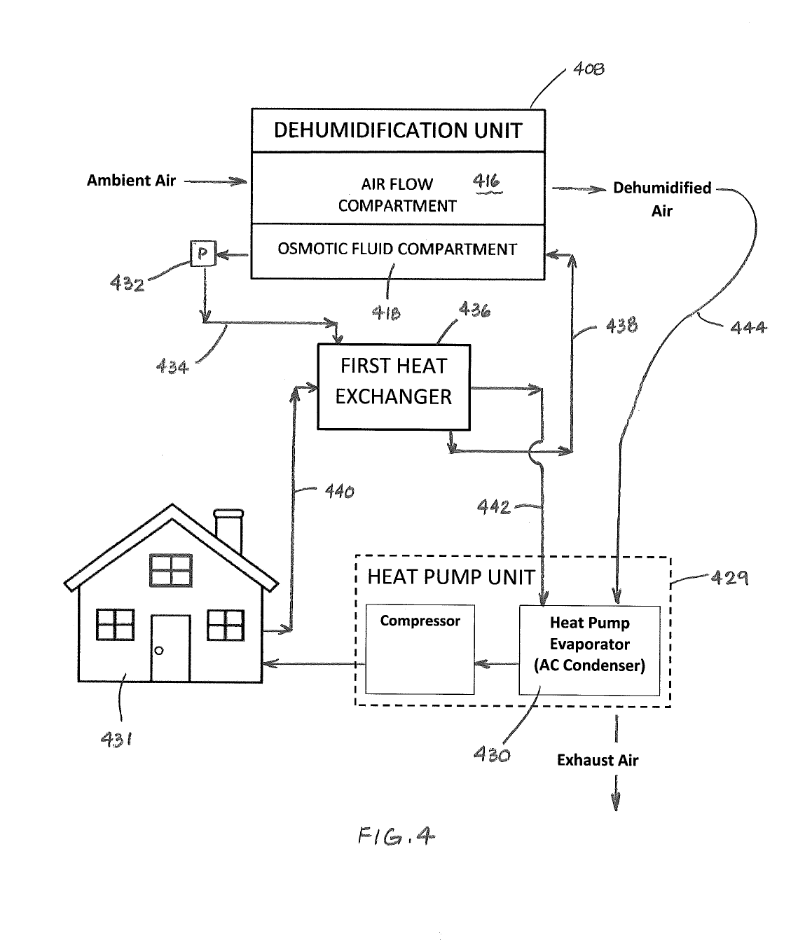

Now referring to FIG. 4, in a second novel and desirable application a dehumidification unit 408 according to the present disclosure may be used with a central air conditioning system (which system includes refrigerant flowing through an evaporator, a condenser, and a compressor) operating as a heat pump system 429. In a “heat pump” mode, the system evaporator (disposed within the building 431) operates as a condenser and produces heat. The system condenser 430 (disposed outside of the building) operates as an evaporator. Condensers are available in a variety of different forms, but typically include a heat exchanger portion. When the air conditioning system is operating as a heat pump (with the condenser 430 acting as an evaporator), the heat exchanger portion of the condenser 430 will have surfaces at a temperature colder than ambient outdoor air. In this operation, water vapor within humid ambient air can attach to surfaces of the condenser 430 in the form of frost, which frost will negatively affect the ability of the condenser 430 to operate as an evaporator.

In this application of the present disclosure, a dehumidification unit 408 can be used to inhibit the formation of frost on surfaces of the outdoor located condenser 430 (or other system surfaces) in two manners. First, a pump 432 (or other fluid moving device) draws osmotic fluid from the osmotic fluid compartment 418 of a dehumidification unit 408 like that described above and passes the osmotic fluid (via piping 434) to a first heat exchanger 436. The osmotic fluid passes through the first heat exchanger 436 and returns to the osmotic fluid compartment 418 (via piping 438). As described above, the heat pump 429 cycles a refrigerant through various components (e.g., an evaporator, a condenser, and a compressor) to produce heat within the building. In that cyclical loop, refrigerant enters (via piping 440) the first heat exchanger 436 and passes through the other side of the first heat exchanger 436 (the refrigerant and the osmotic fluid do not mix). During the passage of refrigerant through the first heat exchanger 436, the refrigerant is heated by the osmotic fluid. The refrigerant subsequently exits the first heat exchanger 436 (via piping 442) and travels to the condenser 430 (acting as the evaporator within the heat pump). The refrigerant subsequently travels through the condenser 430, and subsequently through the compressor before repeating the cycle.

As indicated above, when the refrigerant passes through the condenser 430 a portion of the condenser 430 acts as a heat exchanger, adding thermal energy to the refrigerant. The heat exchanger portion surfaces of the condenser 430 are cooled to a temperature colder than ambient outdoor air. To mitigate or prevent the development of frost on those condenser surfaces, the present system draws ambient air into the airflow compartment 416 of the dehumidification unit 408 (e.g., using a pump), dehumidifies that air as described above, and subsequently passes the dehumidified air (via duct 444) to the condenser portion 430 of the heat pump 429. The condenser heat exchanger surfaces, and therefore the refrigerant passing through the condenser, are heated by the dehumidified air. Because the dehumidified air contains less water vapor than ambient air, the propensity for frost to be produced on the condenser heat transfer surfaces is mitigated or eliminated. This application of the present dehumidification device therefore heats the refrigerant in two different manners.

Although the invention has been described and illustrated with respect to the exemplary embodiments thereof, it should be understood by those skilled in the art that the foregoing and various other changes, omissions and additions may be made without departing from the spirit and scope of the invention.

What is claimed is:

1. An apparatus for dehumidification of a gas stream, comprising:
a single semi-permeable osmotic membrane having a thickness extending between a first side surface and a second side surface, which membrane comprises a plurality of hydrophobic surfaced pores, at least some of which hydrophobic surfaced pores are water vapor condensing pores, which water vapor condensing pores are sized such that the hydrophobic surfaces of those pores allow water vapor to enter those pores and repulse the water vapor within those pores away from the hydrophobic surfaces causing the water vapor to condense, and which hydrophobic surfaced pores provide a liquid travel path across the thickness of the membrane, and which single membrane restricts transport of an osmotic fluid across the thickness of the membrane;
at least one gas stream compartment through which the gas stream may flow, formed in part by the osmotic membrane, wherein the first side of the osmotic membrane is positioned so as to be exposed to the gas stream within the gas stream compartment; and
at least one osmotic fluid compartment found in part by the osmotic membrane, wherein the second side of the osmotic membrane is contiguous with the osmotic fluid compartment.

2. The apparatus of claim 1, wherein the water vapor condensing pores each have a diameter in the range of about 0.8 nanometers to about 1.4 nanometers.

3. The apparatus of claim 2, wherein a substantial percentage of the hydrophobic surfaced pores within the membrane are water vapor condensing pores.

4. The apparatus of claim 3, wherein the membrane consists of a hydrophobic material.

5. The apparatus of claim 1, further comprising an osmotic fluid disposed in the osmotic fluid compartment, which osmotic fluid contains solute molecules.

6. The apparatus of claim 5, wherein the water vapor condensing pores are sized to appreciably prevent the solute molecules within the osmotic fluid from entering the osmotic membrane.

7. The apparatus of claim 5, wherein water vapor condensing pores are sized to appreciably prevent the solute molecules within the osmotic fluid from appreciably blocking the osmotic membrane pores.

8. A process for dehumidifying a gas stream, comprising the steps of:
providing an osmotic fluid;
providing a single semi-permeable hydrophobic osmotic membrane having a thickness extending between a first side surface and a second side surface, which membrane comprises a plurality of hydrophobic surfaced pores, at least some of which are hydrophobic pores and are water vapor condensing pores, which water vapor condensing pores are sized such that the hydrophobic surfaces of those pores allow water vapor to enter those pores and repulse the water vapor within those pores away from the hydrophobic surfaces causing the water vapor to condense and travel through a liquid travel path across the thickness of the membrane, and which single membrane restricts transport of an osmotic fluid across the thickness of the membrane;
placing the osmotic fluid in a compartment fowled in part by the semi-permeable membrane, wherein the second side of the osmotic membrane is exposed to the osmotic fluid;
exposing the first side of the osmotic membrane to the gas stream to be dehumidified; and
maintaining a sufficiently high water concentration gradient across the osmotic membrane during the dehumidification process to result in a flux of water through the osmotic membrane.

9. The process of claim 8, wherein the water vapor condensing pores each have a diameter in the range of about 0.8 nanometers to about 1.4 nanometers.

10. The process of claim 9, wherein a substantial percentage of the hydrophobic surfaced pores within the membrane are water vapor condensing pores.

11. The process of claim 10, wherein the membrane consists of a hydrophobic material.

12. A refrigeration system, comprising:
a refrigeration unit having an interior volume and a cooling unit configured to cool air disposed within the interior volume to a temperature below ambient;
an airflow dehumidification unit having:
a semi-permeable osmotic membrane having a thickness extending between a first side surface and a second side surface, which membrane comprises a plurality of pores, which pores provide a liquid travel path across the thickness of the membrane, and which single membrane restricts transport of an osmotic fluid across the thickness of the membrane;
at least one airflow compartment through which an airflow may flow, formed in part by the osmotic membrane, wherein the first side of the osmotic membrane is positioned so as to be exposed to the airflow within the airflow compartment; and
at least one osmotic fluid compartment formed in part by the osmotic membrane, wherein the second side of the osmotic membrane is contiguous with the osmotic fluid compartment; and
airflow ducting configured to contain the airflow from the interior volume of the refrigeration unit to an inlet of the airflow compartment, and from an exit of the airflow compartment to the interior volume of the refrigeration unit.

13. The refrigeration device of claim 12, wherein the semi-permeable osmotic membrane comprises a plurality of hydrophobic surfaced pores, at least some of which are hydrophobic pores and are water vapor condensing pores, which water vapor condensing pores are sized such that the hydrophobic surfaces of those pores allow water vapor to enter those pores and repulse the water vapor within those pores away from the hydrophobic surfaces causing the water vapor to condense.

14. The refrigeration device of claim 13, wherein the water vapor condensing pores each have a diameter in the range of about 0.8 nanometers to about 1.4 nanometers.

15. The refrigeration device of claim 14, wherein a substantial percentage of the hydrophobic surfaced pores within the membrane are water vapor condensing pores.

16. The refrigeration device of claim 12, wherein the dehumidification device includes an osmotic fluid disposed in the osmotic fluid compartment, which osmotic fluid contains solute molecules.

17. A heat pump system for a building, comprising:
a heat pump having a refrigerant, a refrigerant piping loop through which the refrigerant travels, and an evaporator disposed outside of the building, which evaporator is exposed to ambient air;
an airflow dehumidification unit having:
a semi-permeable osmotic membrane having a thickness extending between a first side surface and a second side surface, which membrane comprises a plurality of pores, which pores provide a liquid travel path across the thickness of the membrane, and which membrane restricts transport of an osmotic fluid across the thickness of the membrane;
at least one airflow compartment through which an airflow may flow, faulted in part by the osmotic membrane, wherein the first side of the osmotic membrane is positioned so as to be exposed to the airflow within the airflow compartment; and
at least one osmotic fluid compartment formed in part by the osmotic membrane, wherein the second side of the osmotic membrane is contiguous with the osmotic fluid compartment;
a two-fluid heat exchanger having a refrigerant inlet and a refrigerant outlet, an osmotic fluid inlet, and an osmotic fluid outlet;
piping providing an enclosed osmotic fluid path loop from the osmotic fluid compartment to the osmotic fluid inlet of the heat exchanger, and from the osmotic fluid exit of the heat exchanger back to the osmotic fluid compartment; and
airflow ducting configured to provide an enclosed passage for an airflow exiting the airflow compartment to the evaporator.

18. The heat pump system of claim 17, wherein the semi-permeable osmotic membrane comprises a plurality of hydrophobic surfaced pores, at least some of which are hydrophobic pores are water vapor condensing pores, which water vapor condensing pores are sized such that the hydrophobic surfaces of those pores allow water vapor to enter those pores and repulse the water vapor within those pores away from the hydrophobic surfaces causing the water vapor to condense.

19. The heat pump system of claim 18, wherein the water vapor condensing pores each have a diameter in the range of about 0.8 nanometers to about 1.4 nanometers.

20. The heat pump system of claim 19, wherein a substantial percentage of the hydrophobic surfaced pores within the membrane are water vapor condensing pores.
